(19) United States
(12) Patent Application Publication
(10) Pub. No.: US 2013/0325436 A1
(43) Pub. Date: Dec. 5, 2013

(54) Large Scale Distributed Syntactic, Semantic and Lexical Language Models

(71) Applicants: Shaojun Wang, Centerville, OH (US); Ming Tan, Fairborn, OH (US)

(72) Inventors: Shaojun Wang, Centerville, OH (US); Ming Tan, Fairborn, OH (US)

(73) Assignee: WRIGHT STATE UNIVERSITY, Dayton, OH (US)

(21) Appl. No.: 13/482,529

(22) Filed: May 29, 2012

(51) Int. Cl. G06F 17/27; G10L 15/18

(52) U.S. Cl. 704/9; 704/E15.018

(57) ABSTRACT

A composite language model may include a composite word predictor. The composite word predictor may include a first language model and a second language model that are combined according to a directed Markov random field. The composite word predictor can predict a next word based upon a first set of contexts and a second set of contexts. The first language model may include a first word predictor that is dependent upon the first set of contexts. The second language model may include a second word predictor that is dependent upon the second set of contexts. Composite model parameters can be determined by multiple iterations of a convergent N-best list approximate Expectation-Maximization algorithm and a follow-up Expectation-Maximization algorithm applied in sequence, wherein the convergent N-best list approximate Expectation-Maximization algorithm and the follow-up Expectation-Maximization algorithm extracts the first set of contexts and the second set of contexts from a training corpus.

### CROSS-REFERENCE TO RELATED APPLICATIONS

This application claims the benefit of U.S. Provisional Application No. 60/496,502, filed Jun. 13, 2011.

### TECHNICAL FIELD

The present specification generally relates to language models for modeling natural language and, more specifically, to syntactic, semantic or lexical language models for machine translation, speech recognition and information retrieval.

### BACKGROUND

Natural language may be decoded by Markov chain source models, which encode local word interactions. However, natural language may have a richer structure than can be conveniently captured by Markov chain source models. Many recent approaches have been proposed to capture and exploit different aspects of natural language regularity with the goal of outperforming the Markov chain source model. Unfortunately each of these language models only targets some specific, distinct linguistic phenomena. Some work has been done to combine these language models with limited success. Previous techniques for combining language models commonly make unrealistic strong assumptions, i.e., linear additive form in linear interpolation, or intractable model assumption, i.e., undirected Markov random fields (Gibbs distributions) in maximum entropy.

Accordingly, a need exists for alternative composite language models for machine translation, speech recognition and information retrieval.

### SUMMARY

In one embodiment, a composite language model may include a composite word predictor. The composite word predictor the composite word predictor can be stored in one or more memories such as, for example, memories that are communicably coupled to processors in one or more servers. The composite word predictor can predict, automatically with one or more processors that are communicably coupled to the one or more memories, a next word based upon a first set of contexts and a second set of contexts. The first language model may include a first word predictor that is dependent upon the first set of contexts. The second language model may include a second word predictor that is dependent upon the second set of contexts. Composite model parameters can be determined by multiple iterations of a convergent N-best list approximate Expectation-Maximization algorithm and a follow-up Expectation-Maximization algorithm applied in sequence, wherein the convergent N-best list approximate Expectation-Maximization algorithm and the follow-up Expectation-Maximization algorithm extracts the first set of contexts and the second set of contexts from a training corpus.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a composite n-gram/m-SLM/PLSA word predictor where the hidden information is the parse tree T and the semantic content g according to one or more embodiments shown and described herein; and

FIG. 2 schematically depicts a distributed architecture according to a Map Reduce paradigm according to one or more embodiments shown and described herein.

### DETAILED DESCRIPTION

According to the embodiments described herein, large scale distributed composite language models may be formed in order to simultaneously account for local word lexical information, mid-range sentence syntactic structure, and long-span document semantic content under a directed Markov random field (MRF) paradigm. Such composite language models may be trained by performing a convergent N-best list approximate Expectation-Maximization (EM) algorithm that has linear time complexity and a follow-up EM algorithm to improve word prediction power on corpora with billions of tokens, which can be stored on a supercomputer or a distributed computing architecture. Various embodiments of composite language models, methods for forming the same, and systems employing the same will be described in more detail herein.

As is noted above, a composite language model may be formed by combining a plurality of stand alone language models under a directed MRF paradigm. The language models may include models which account for local word lexical information, mid-range sentence syntactic structure, or long-span document semantic. Suitable language models for combination under the under a directed MRF paradigm include, for example, incorporate probabilistic context free grammar (PCFG) models, Markov chain source models, structured language models, probabilistic latent semantic analysis models, latent Dirichlet allocation models, correlated topic models, dynamic topic models, and any other known or yet to be developed model that accounts for local word lexical information, mid-range sentence syntactic structure, or long-span document semantic. Accordingly, it is note that, while the description provided herein is directed to composite language models formed from any two of Markov chain source models, structured language models, and probabilistic latent semantic analysis models, the composite language models described herein may be formed from any two language models.

A Markov chain source model (hereinafter “n-gram” model) comprises a word predictor that predicts a next word. The word predictor of the n-gram model that predicts a next word wₖ₊₁, when given its entire document history, based on the last n−1 words with probability p(wₖ₊₁|wₖ₋ₙ₊₂^{k}) where wₖ₋ₙ₊₂^{k}=wₖ₋ₙ₊₂^{k}, . . . , wₖ. Such n-gram models may be efficient at encoding local word interactions.

A structured language model (hereinafter “SLM”) may include syntactic information to capture sentence level long range dependencies. The SLM is based on statistical parsing techniques that allow syntactic analysis of sentences to assign a probability p(W,T) to every sentence W and every possible binary parse T. The terminals of T are the words of W with POS tags. The nodes of T are annotated with phrase headwords and non-terminal labels. Let W be a sentence of length n words to which we have prepended the sentence beginning marker <s> and appended the sentence end marker </s> so that w₀=<s> and wₙ₊₁=</s>. Let Wₖ=w₀, . . . , wₖ be the word k-prefix of the sentence, i.e., the words from the beginning of the sentence up to the current position k and WₖTₖ the word-parse k-prefix. A word-parse k-prefix has a set of exposed heads h₋ₘ, . . . , h₋₁, with each head being a pair (headword, non-terminal label), or in the case of a root-only tree (word, FOS tag). For example in one embodiment, an m-th order SLM (m-SLM) comprises three operators to generate a sentence. A word predictor that predicts the next word wₖ₊₁ based on the m left-most exposed headwords h₋ₘ⁻¹=h₋ₘ, . . . , h₋₁ in the word-parse k-prefix with probability p(wₖ₊₁|h₋ₘ⁻¹), and then passes control to the tagger. The tagger predicts the POS tag tₖ₊₁ to the next word wₖ₊₁ based on the next word wₖ₊₁ and the POS tags of the m left-most exposed headwords h₋ₘ⁻¹ in the word-parse k-prefix with probability p(tₖ₊₁|wₖ₊₁,h₋ₘ.tag, . . . , h₋₁.tag). The constructor builds the partial parse Tₖ from Tₖ₋₁, wₖ, and tₖ in a series of moves ending with null. A parse move a is made with probability p(a|h₋ₘ⁻¹); a ∈ A={(unary, NTlabel), (adjoinleft, NTlabel), (adjoin-right, NTlabel), null}. Once the constructor hits null, it passes control to the word predictor.

A probabilistic latent semantic analysis (hereinafter “PLSA”) model is a generative probabilistic model of word-document co-occurrences using a bag-of-words assumption, which may perform the actions described below. A document d is chosen with probability p(d). A semantizer selects a semantic class g with probability p(g|d). A word predictor picks a word w with probability p(w|g). Since only one pair of (d,w) is being observed, the joint probability model is a mixture of a log-linear model with the expression p(d,w)=p(d)Σ_{g}p(w|g)p(g|d). Accordingly, the number of documents and vocabulary size can be much larger than the size of latent semantic class variables.

According to the directed MRF paradigm, the word predictors of any two language models may be combined to form a composite word predictor. For example, any two of the n-gram model, the SLM, and the PLSA model may be combined to form a composite word predictor. Thus, the composite word predictor can predict a next word based upon a plurality of contexts (e.g., the n-gram history wₖ₋ₙ₊₂^{k}, the m left-most exposed headwords h₋ₘ⁻¹=h₋ₘ, . . . , h₋₁, and the semantic content gₖ₊₁). Moreover, under the directed MRF paradigm, the other components (e.g., tagger, constructor, and semantizer) of the language models may remain unchanged.

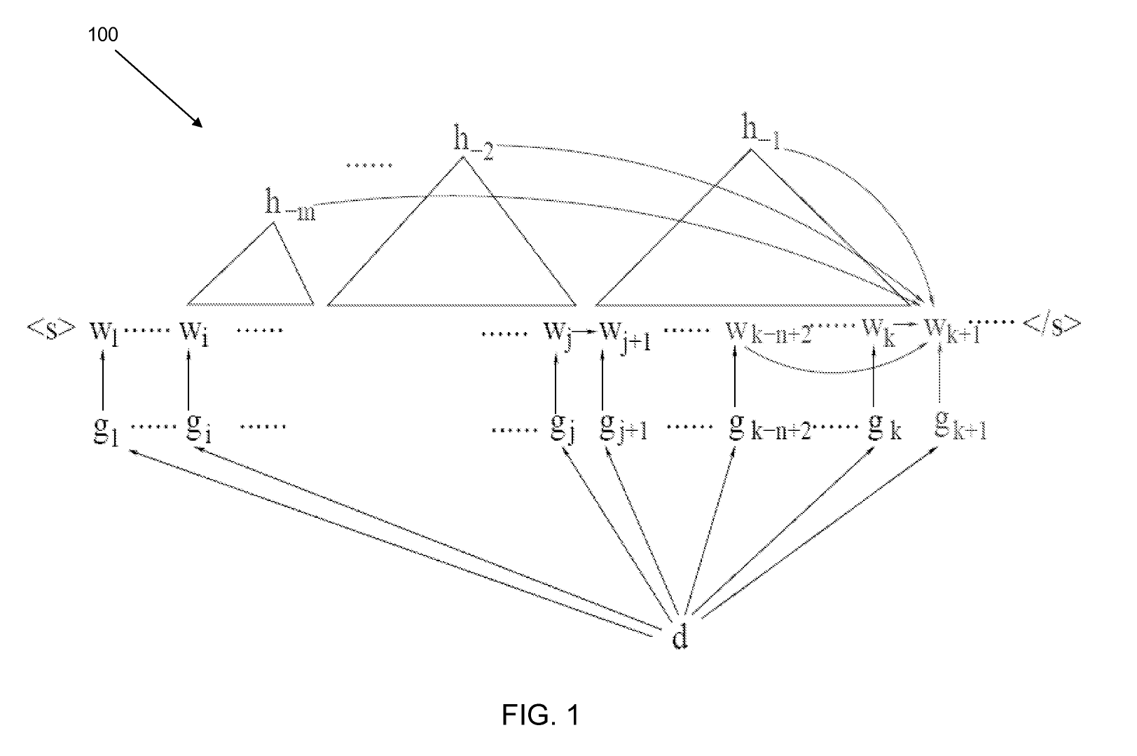

Referring now to FIG. 1, a composite language model may be formed according to the directed MRF paradigm to by combining an n-gram model, an m-SLM and a PLSA model (composite n-gram/m-SLM/PLSA language model). The composite word predictor 100 composite of n-gram/m-SLM/PLSA language model generates the next word, wₖ₊₁, based upon the n-gram history wₖ₋ₙ₊₂^{k}, the m left-most exposed headwords h₋ₘ⁻¹=h₋ₘ, . . . , h₋₁, and the semantic content gₖ₊₁. Accordingly, the parameter for the composite word predictor 100 can be given by p(wₖ₊₁|wₖ₋ₙ₊₂^{k}h₋ₘ⁻¹gₖ₊₁).

The composite n-gram/m-SLM/PLSA language model can be formalized as a directed MRF model with local normalization constraints for the parameters of each model component. Specifically, the composite word predictor may be given by

$${\sum }_{w ∈ 𝒱} p ( w \vert {w}_{- n + 1}^{- 1} {h}_{- m}^{- 1} g ) = 1 ,$$

the tagger may be given by

$${\sum }_{t ∈ 𝒪} p ( t \vert {wh}_{- m}^{- 1} \cdot tag ) = 1 ,$$

the constructor may be given by

$${\sum }_{a ∈ 𝒜} p ( a \vert {h}_{- m}^{- 1} ) = 1 ,$$

and the semantizer may be given by

$${\sum }_{g ∈ 𝒢} p ( g \vert d ) = 1.$$

The likelihood of a training corpus D, a collection of documents, for the composite n-gram/m-SLM/PLSA language model can be written as:

$$\hat{ℒ} ( 𝒟 , p ) = {\prod }_{d ∈ 𝒟} ( ( {\prod }_{l} ( {\sum }_{{G}^{l}} ( {\sum }_{{T}^{l}} {P}_{P} ( {W}^{l} , {T}^{l} , {G}^{l} \vert d ) ) ) ) p ( d ) )$$

where (W^{l}, T^{l}, G^{l}|d) denote the joint sequence of the l^{th} sentence W^{l} with its parse tree structure T^{l} and semantic annotation string G^{l} in document d. This sequence is produced by the sequence of model actions: word predictor, tagger, constructor, semantizer moves. Its probability is obtained by chaining the probabilities of the moves

$${P}_{P} ( {W}^{l} , {T}^{l} , {G}^{l} \vert d ) = {\prod }_{g ∈ 𝒢} ( {p ( g \vert d )}^{\# ( g , {W}^{l} , {G}^{l} , d )} {\prod }_{{h}_{- 1} , … , {h}_{- m} ∈ ℋ} ( {\prod }_{w , {w}_{- 1} , … , {w}_{- n + 1} ∈ 𝒱} {p ( w \vert {w}_{- n + 1}^{- 1} {h}_{- m}^{- 1} g )}^{\# ( {w}_{- n + 1}^{- 1} {wh}_{- m}^{- 1} g , {W}^{l} , {T}^{l} , {G}^{l} , d )} {\prod }_{t ∈ 𝒪} {p ( t \vert {wh}_{- m}^{- 1} \cdot tag )}^{\# ( t , {wh}_{- m}^{- 1} \cdot tag , {W}^{l} , {T}^{l} , d )} {\prod }_{a ∈ 𝒜} {p ( a \vert {h}_{- m}^{- 1} )}^{\# ( a , {h}_{- m}^{- 1} , {W}^{l} , {T}^{l} , d )} ) )$$

where #(g, W^{l}, G^{l}, d) is the count of semantic content g in semantic annotation string G^{l} of the sentence l^{th} in document d, #(w₋ₙ₊₁⁻¹wh₋ₘ⁻¹g, W^{l}, T^{l}, G^{l}, d) is the count of n-grams, its m most recent exposed headwords and semantic content g in parse T^{l} and semantic annotation string G^{l} of the l^{th} sentence W^{l} in document d, #(twh₋ₘ⁻¹.tag, W^{l}, T^{l},d) is the count of tag t predicted by word w and the tags of m most recent exposed headwords in parse tree T^{l} of the l^{th} sentence W^{l} in document d, and #(ah₋ₘ⁻¹, W^{l}, T^{l}, d) is the count of constructor move a conditioning on in exposed headwords h₋ₘ⁻¹ in parse tree T^{l} of the l^{th} sentence W^{l} in document d.

As is noted above, any two or more language models may be combined according to the directed MRF paradigm by forming a composite word predictor. The likelihood of a training corpus D may be determined by chaining the probabilities of model actions. For example, a composite n-gram/m-SLM language model can be formulated according to the directed MRF paradigm with local normalization constraints for the parameters of each model component. Specifically, the composite word predictor may be given by

$${\sum }_{w ∈ 𝒱} p ( w \vert {w}_{- n + 1}^{- 1} {h}_{- m}^{- 1} ) = 1 ,$$

the tagger may be given by

$${\sum }_{t ∈ 𝒪} p ( t \vert {wh}_{- m}^{- 1} \cdot tag ) = 1 ,$$

the constructor may be given by

$${\sum }_{a ∈ 𝒜} p ( a \vert {h}_{- m}^{- 1} ) = 1.$$

For the composite n-gram/m-SLM language model under the directed MRF paradigm, the likelihood of a training corpus D, can be written as:

$$\hat{ℒ} ( 𝒟 , p ) = {\prod }_{d ∈ 𝒟} ( ( {\prod }_{l} ( {\sum }_{{T}^{l}} {P}_{P} ( {W}^{l} , {T}^{l} \vert d ) ) ) p ( d ) )$$

where (W^{l}, T^{l}|d) denotes the joint sequence of the l^{th} sentence W^{l} with its parse structure T^{l} in document d. This sequence is produced by the sequence of model actions: word predictor, tagger and constructor. The probability is obtained by chaining the probabilities of these moves

$${P}_{P} ( {W}^{l} , {T}^{l} \vert d ) = ( {\prod }_{{h}_{- 1} , … , {h}_{- m} ∈ ℋ} ( {\prod }_{w , {w}_{- 1} , … , {w}_{- n + 1} ∈ 𝒱} {p ( w \vert {w}_{- n + 1}^{- 1} {h}_{- m}^{- 1} )}^{\# ( {w}_{- n + 1}^{- 1} {wh}_{- m}^{- 1} , {W}^{l} , {T}^{l} , d )} {\prod }_{t ∈ 𝒪} {p ( t \vert {wh}_{- m}^{- 1} \cdot tag )}^{\# ( t , {wh}_{- m}^{- 1} \cdot tag , {W}^{l} , {T}^{l} , d )} {\prod }_{a ∈ 𝒜} {p ( a \vert {h}_{- m}^{- 1} )}^{\# ( a , {h}_{- m}^{- 1} , {W}^{l} \cdot {T}^{l} \cdot d )} ) )$$

where #(w₋ₙ₊₁⁻¹wh₋ₘ⁻¹, W^{l}, T^{l}, d) is the count of n-grams, its m most recently exposed headwords in parse T^{l} and of the l^{th}sentence W^{l} in document d, #(twh₋ₘ⁻¹.tag, W^{l}, T^{l}, d) is the count of tag t predicted by word W and the tags of m most recently exposed headwords in parse tree T^{l} of the l^{th} sentence W^{l} in document d, and #(ah₋ₘ⁻¹, W^{l}, T^{l}, d) is the count of constructor move a conditioning on m exposed headwords h₋ₘ⁻¹ in parse tree T^{l} of the l^{th} sentence W^{l} in document d.

A composite m-SLM/PLSA language model can be formulated under the directed MRF paradigm with local normalization constraints for the parameters of each model component. Specifically, the composite word predictor may be given by

$${\sum }_{w ∈ 𝒱} p ( w \vert {h}_{- m}^{- 1} g ) = 1 ,$$

the tagger may be given by

$${\sum }_{t ∈ 𝒪} p ( t \vert {wh}_{- m}^{- 1} \cdot tag ) = 1 ,$$

the constructor may be given by

$${\sum }_{a ∈ 𝒜} p ( a \vert {h}_{- m}^{- 1} ) = 1 ,$$

and the semantizer may be given by

$${\sum }_{g ∈ 𝒢} p ( g \vert d ) = 1.$$

For the composite m-SLM/PLSA language model under the directed MRF paradigm, the likelihood of a training corpus D can be written as

$$\hat{ℒ} ( 𝒟 , p ) = {\prod }_{d ∈ 𝒟} ( ( {\prod }_{l} ( {\sum }_{{G}^{l}} ( {\sum }_{{T}^{l}} {P}_{P} ( {W}^{l} , {T}^{l} , {G}^{l} \vert d ) ) ) ) p ( d ) )$$

where (W^{l}, T^{l}, G^{l}|d) denote the joint sequence of the l^{th} sentence W^{l} with its parse tree structure T^{l} and semantic annotation string G^{l} in document d. This sequence is produced by the sequence of model actions: word predictor, tagger, constructor and semantizer. The probability is obtained by chaining the probabilities of these moves

$${P}_{p} ( {W}^{l} , {T}^{l} , {G}^{l} \vert d ) = {\prod }_{g ∈ 𝒢} ( {p ( g \vert d )}^{\# ( g , {W}^{l} , {G}^{l} , d )} ( {\prod }_{{h}_{- 1} , … , {h}_{- m} ∈ ℋ} {p ( w \vert {h}_{- m}^{- 1} g )}^{\# ( {wh}_{- m}^{- 1} g , {W}^{l} , {T}^{l} , {G}^{l} , d )} {\prod }_{t ∈ 𝒪} {p ( t \vert {wh}_{- m}^{- 1} \cdot tag )}^{\# ( t , {wh}_{- m}^{- 1} \cdot tag , {W}^{l} , {T}^{l} , d )} {\prod }_{a ∈ A} {p ( a \vert {h}_{- m}^{- 1} )}^{\# ( a , {b}_{- m}^{- 1} , {W}^{l} , {T}^{l} , d )} ) )$$

where #(g, W^{l}, G^{l}, d) is the count of semantic content g in semantic annotation string G^{l} of the l^{th} sentence W^{l} in document d, #(wh₋ₘ⁻¹g, W^{l}, T^{l}, G^{l}, d) is the count of word w, its m most recent exposed headwords and semantic content g in parse T^{l} and semantic annotation string G^{l} of the l^{th} sentence W^{l} in document d, #(twh₋ₘ⁻¹.tag, W^{l}, T^{l}, d) is the count of tag t predicted by word w and the tags of m most recent exposed headwords in parse tree T^{l} of the l^{th} sentence W^{l} in document d, and #(ah₋ₘ⁻¹, W^{l}, T^{l}, d) is the count of constructor move a conditioning on m exposed headwords h₋ₘ⁻¹ in parse tree T^{l} of the l^{th} sentence W^{l} in document d.

A composite n-gram/PLSA language model can be formulated under the directed MRF paradigm with local normalization constraints for the parameters of each model component. Specifically, the composite word predictor may be given by

$${\sum }_{w ∈ 𝒱} p ( w \vert {w}_{- n + 1}^{- 1} g ) = 1 ,$$

and the semantizer may be given by

$${\sum }_{g ∈ 𝒢} p ( g \vert d ) = 1$$

For the composite n-gram/PLSA language model under the directed MRF paradigm, the likelihood of a training corpus D can be written as

$$\hat{ℒ} ( 𝒟 , p ) = {\prod }_{d ∈ 𝒟} ( ( {\prod }_{l} ( {\sum }_{{G}^{l}} {P}_{p} ( {W}^{l} , {G}^{l} \vert d ) ) ) p ( d ) )$$

where (Wl,Gl|d) denotes the joint sequence of the lth sentence Wl semantic annotation string Gl in document d. where (W^{l}, G^{l}|d) denote the joint sequence of the l^{th} sentence W^{l} and semantic annotation string G^{l} in document d. This sequence is produced by the sequence of model actions: word predictor and semantizer. The probability is obtained by chaining the probabilities of these moves

$${P}_{p} ( {W}^{l} , {G}^{l} \vert d ) = {\prod }_{g ∈ 𝒢} ( {p ( g \vert d )}^{\# ( g , {W}^{l} , {G}^{l} , d )} ( {\prod }_{w , {w}_{- 1} , … , {w}_{- n + 1} ∈ 𝒱} {p ( w \vert {w}_{- n + 1}^{- 1} g )}^{\# ( {w}_{- n + 1}^{- 1} wg , {W}^{l} , {G}^{l} , d )} ) )$$

where #(g, W^{l}, G^{l}, d) is the count of semantic content g in semantic annotation string G^{l} of the l^{th} sentence W^{l} in document d, #(wh₋ₙ₊₁⁻¹,wg, W^{l}, T^{l}, G^{l}, d) is the count of n-grams, and semantic content g in semantic annotation string G^{l} of the l^{th} sentence W^{l} in document d.

An N-best list approximate EM re-estimation with modular modifications to may be utilized to incorporate the effect of n-gram and PLSA components. The N-best list likelihood can be maximized according to

$${max}_{{𝒯}_{N}^{′}} ℒ ( 𝒟 , p , {𝒯}_{N}^{′} ) = {\prod }_{d ∈ 𝒟} ( {\prod }_{l} ( {max}_{{𝒯}_{N}^{′ l} ∈ {𝒯}_{N}^{′}} ( {\sum }_{{G}^{l}} ( {\sum }_{{T}^{l} ∈ {T}_{N}^{′ l} , ‖ {𝒯}_{N}^{′ l} ‖ = N} {P}_{p} ( {W}^{l} , {T}^{l} , {G}^{l} \vert d ) ) ) ) )$$

where T′^{l}_{N} is a set of N parse trees for sentence W^{l} in document d and ∥∥ denotes the cardinality and T′_{N} is a collection of T′^{l}_{N} for sentences over entire corpus D.

The N-best list approximate EM involves two steps. First, the N-best list search is performed for each sentence W in document d, find N-best parse trees,

$${𝒯}_{N}^{l} = arg {max}_{{𝒯}_{N}^{′ l}} \{ {\sum }_{{G}^{l}} {\sum }_{{T}^{l} ∈ {𝒯}_{N}^{′ l}} {P}_{p} ( {W}^{l} , {T}^{l} , {G}^{l} \vert d ) , ‖ {𝒯}_{N}^{′ l} ‖ = N \}$$

and denote T_{N} as the collection of N-best list parse trees for sentences over entire corpus D under model parameter p. Second, perform one or more iteration of EM algorithm (EM update) to estimate model parameters that maximizes N-best-list likelihood of the training corpus D,

$$\tilde{ℒ} ( 𝒟 , p , {𝒯}_{N} ) = {\prod }_{d ∈ 𝒟} ( {\prod }_{l} ( {\sum }_{{G}^{l}} ( {\sum }_{{T}^{l} ∈ {𝒯}_{N}^{l} ∈ {𝒯}_{N}} {P}_{p} ( {W}^{l} , {T}^{l} , {G}^{l} \vert d ) ) ) )$$

That is, in the E-step: Compute the auxiliary function of the N-best-list likelihood

$$\tilde{𝒬} ( {p}^{l} , p , {𝒯}_{N} ) = {\sum }_{d ∈ 𝒟} {\sum }_{l} {\sum }_{{G}^{l}} {\sum }_{{T}^{l} ∈ {𝒯}_{N}^{l} ∈ {𝒯}_{N}} {P}_{p} ( {T}^{l} , {G}^{l} \vert {W}^{l} , d ) log {P}_{{p}^{′}} ( {W}^{l} , {T}^{l} , {G}^{l} \vert d )$$

In the M-step: Maximize \tilde{Q}(p′, p, T_{N}) with respect to p′ to get new update for p. The first and the second step can be iterated until the convergence of the N-best-list likelihood.

To extract the N-best parse trees, a synchronous, multi-stack search strategy may be utilized. The synchronous, multi-stack search strategy involves a set of stacks storing partial parses of the most likely ones for a given prefix Wₖ and the less probable parses are purged. Each stack contains hypotheses (partial parses) that have been constructed by the same number of word predictor and the same number of constructor operations. The hypotheses in each stack can be ranked according to the log(Σ_{G}_{ₖ}Pₚ(Wₖ, Tₖ, Gₖ|d)) score with the highest on top, where Pₚ(Wₖ, Tₖ, Gₖ|d) is the joint probability of prefix Wₖ=w₀, . . . , wₖ with its parse structure Tₖ and semantic annotation string Gₖ=g₁, . . . , gₖ in a document d. A stack vector comprises the ordered set of stacks containing partial parses with the same number of word predictor operations but different number of constructor operations. In word predictor and tagger operations, some hypotheses are discarded due to the maximum number of hypotheses the stack can contain at any given time. In constructor operation, the resulting hypotheses are discarded due to either finite stack size or the log-probability threshold: the maximum tolerable difference between the log-probability score of the top-most hypothesis and the bottom-most hypothesis at any given state of the stack.

Once the N-best parse trees for each sentence in document d and N-best topics for document d have been determined, the EM algorithm to estimate model parameters may be derived. In E-step, the expected count of each model parameter can be computed over sentence W^{l} in document d in the training corpus D. Forward-backward recursive formulas can be utilized for the word predictor and the semantizer, the number of possible semantic annotation sequences is exponential. Forward-backward recursive formulas are similar to those in hidden Markov models to compute the expected counts. We define the forward vector αₖ₊₁^{l} (g|d) to be

$${α}_{k + 1}^{l} ( g \vert d ) = {\sum }_{{G}_{k}^{l}} {P}_{p} ( {W}_{k}^{l} , {T}_{k}^{l} , {w}_{k - n + 2}^{k} {w}_{k + 1} {h}_{- m}^{- 1} g , {G}_{k}^{l} \vert d )$$

that can be recursively computed in a forward manner, where Wₖ^{l} is the word k-prefix for sentence W^{l}, Tₖ^{l} is the parse for k-prefix. We define backward vector βₖ₊₁^{l}(g|d) to be

$${β}_{k + 1}^{l} ( g \vert d ) = {\sum }_{{G}_{k + 1 , .}^{l}} {P}_{p} ( {W}_{k + 1 , .}^{l} , {T}_{k + 1 , .}^{l} , {G}_{k + 1 , .}^{l} \vert {w}_{k - n + 2}^{k} {w}_{k + 1} {h}_{- m}^{- 1} g , d )$$

that can be computed in a backward manner, here Wₖ₊₁^{l}, is the subsequence after k+1th word in sentence W^{l}, Tₖ₊₁^{l}, is the incremental parse structure after the parse structure Tₖ₊₁^{l} of word k+1-prefix Wₖ₊₁^{l} that generates parse tree T^{l}, Gₖ₊₁^{l}, is the semantic subsequence in G^{l} relevant to Wₖ₊₁^{l}. Then, the expected count of w₋ₙ₊₁⁻¹wh₋ₘ⁻¹g for the word predictor on sentence W^{l} in document d is

$${\sum }_{{G}^{l}} {P}_{p} ( {T}^{l} , {G}^{l} \vert {W}^{l} , d ) \# ( {w}_{- n + 1}^{- 1} {wh}_{- m}^{- 1} g , {W}^{l} , {T}^{l} , {G}^{l} , d ) = {\sum }_{l} {\sum }_{k} {α}_{k + 1}^{l} ( g \vert d ) {β}_{k + 1}^{l} ( g \vert d ) p ( g \vert d )$$

$$δ ( {w}_{k - n + 2}^{k} {w}_{k + 1} {h}_{- m}^{- 1} {g}_{k + 1} = {w}_{- n + 1}^{- 1} {wh}_{- m}^{- 1} g ) / {P}_{p} ( {W}^{l} \vert d )$$

where δ(•) is an indicator function and the expected count of g for the semantizer on sentence W^{l} in document d is

$${\sum }_{{G}^{l}} {P}_{p} ( {T}^{l} , {G}^{l} \vert {W}^{l} , d ) \# ( g , {W}^{l} , {G}^{l} , d ) = {\sum }_{k = 0}^{j - 1} {α}_{k + 1}^{l} ( g \vert d ) {β}_{k + 1}^{l} ( g \vert d ) p ( g \vert d ) / {P}_{p} ( {W}^{l} \vert d )$$

For the tagger and the constructor, the expected ‘count of each event of twh₋ₘ⁻¹.tag and ah₋ₘ⁻¹ over parse T^{l} of sentence W^{l} in document d is the real count appeared in parse tree T^{l} of sentence W^{l} in document d times the conditional distribution

Pₚ(T^{l}|W^{l}, d)=Pₚ(T^{l}, W^{l}|d)/Σ_{T}_{^{l}}_{∈T}_{^{l}}Pₚ(T^{l}, W^{l}|d)

respectively.

In M-step, a recursive linear interpolation scheme can be used to obtain a smooth probability estimate for each model component, word predictor, tagger, and constructor. The tagger and constructor are conditional probabilistic models of the type p(u|z₁, . . . , zₙ) where u, z₁, . . . , zₙ belong to a mixed set of words, POS tags, NTtags, constructor actions (u only), and z₁, . . . , zₙ form a linear Markov chain. A standard recursive mixing scheme among relative frequency estimates of different orders k=0, . . . , n may be used. The word predictor is a conditional probabilistic model p(w|w₋ₙ₊₁⁻¹h₋ₘ⁻¹g) where there are three kinds of context w₋ₙ₊₁⁻¹, h₋ₘ⁻¹ and g, each forms a linear Markov chain. The model has a combinatorial number of relative frequency estimates of different orders among three linear Markov chains. A lattice may be formed to handle the situation where the context is a mixture of Markov chains.

For the SLM, a large fraction of the partial parse trees that can be used for assigning probability to the next word do not survive in the synchronous, multistack search strategy, thus they are not used in the N-best approximate EM algorithm for the estimation of word predictor to improve its predictive power. Accordingly, the word predictor can be estimated using the algorithm below.

The language model probability assignment for the word at position k+1 in the input sentence of document d can be computed as

$${P}_{p} ( {w}_{k + 1} \vert {W}_{k} , d ) = {\sum }_{{h}_{- m}^{- 1} ∈ {T}_{k} ; {T}_{k} ∈ {Z}_{k} , {g}_{k + 1} ∈ {𝒢}_{d}} p ( {w}_{k + 1} \vert {w}_{k - n + 2}^{k} {h}_{- m}^{- 1} {g}_{k + 1} ) {P}_{p} ( {T}_{k} \vert {W}_{k} , d ) p ( {g}_{k + 1} \vert d )$$

$$where$$

$${P}_{p} ( {T}_{k} \vert {W}_{k} , d ) = \frac{{\sum }_{{G}_{k}} {P}_{p} ( {W}_{k} , {T}_{k} , {G}_{k} \vert d )}{{\sum }_{{T}_{k} ∈ {Z}_{k}} {\sum }_{{G}_{k}} {P}_{p} ( {W}_{k} , {T}_{k} , {G}_{k} \vert d )}$$

and Zₖ is the set of all parses present in the stacks at the current stage k during the synchronous multi-stack pruning strategy and it is a function of the word k -prefix Wₖ.

The likelihood of a training corpus D under this language model probability assignment that uses partial parse trees generated during the process of the synchronous, multi-stack search strategy can be written as

$$\tilde{ℒ} ( 𝒟 , p ) = {\prod }_{d ∈ 𝒟} {\prod }_{l} ( {\sum }_{k} {P}_{p} ( {w}_{k + 1}^{( l )} \vert {W}_{k}^{l} , d ) )$$

A second stage of parameter re-estimation can be employed for p(wₖ₊₁|wₖ₋ₙ₊₂^{k}h₋ₘ⁻¹gₖ₊₁) and p(gₖ₊₁|d) by using EM again to maximize the likelihood of a training corpus D given immediately above to improve the predictive power of word predictor. It is noted that, while a convergent N-best list approximate Expectation-Maximization algorithm and a follow-up Expectation-Maximization algorithm are described hereinabove with respect to a composite n-gram/m-SLM/PLSA language model, any of the composite models formed according to the directed MRF paradigm may be trained according the EM algorithms described herein by, for example, removing the portions of the general EM algorithm corresponding to excluded contexts.

When using very large corpora to train our composite language model, both the data and the parameters may be stored on a plurality of machines (e.g., communicably coupled computing devices, clients, supercomputers or servers). Accordingly, each of the machines may comprise one or more processors that are communicably coupled to one or more memories. A processor may be a controller, an integrated circuit, a microchip, a computer, or any other computing device capable of executing machine readable instructions. A memory may be RAM, ROM, a flash memory, a hard drive, or any device capable of storing machine readable instructions. The phrase “communicably coupled” means that components are capable of exchanging data signals with one another such as, for example, electrical signals via conductive medium, electromagnetic signals via air, optical signals via optical waveguides, and the like.

Accordingly, embodiments of the present disclosure can comprise models or algorithms that comprise machine readable instructions that includes logic written in any programming language of any generation (e.g., 1GL, 2GL, 3GL, 4GL, or 5GL) such as, e.g., machine language that may be directly executed by the processor, or assembly language, object-oriented programming (OOP), scripting languages, microcode, etc., that may be compiled or assembled into machine readable instructions and stored on a machine readable medium. Alternatively, the logic may be written in a hardware description language (HDL), such as implemented via either a field-programmable gate array (FPGA) configuration or an application-specific integrated circuit (ASIC), and their equivalents. Accordingly, the machine readable instructions may be implemented in any conventional computer programming language, as pre-programmed hardware elements, or as a combination of hardware and software components.

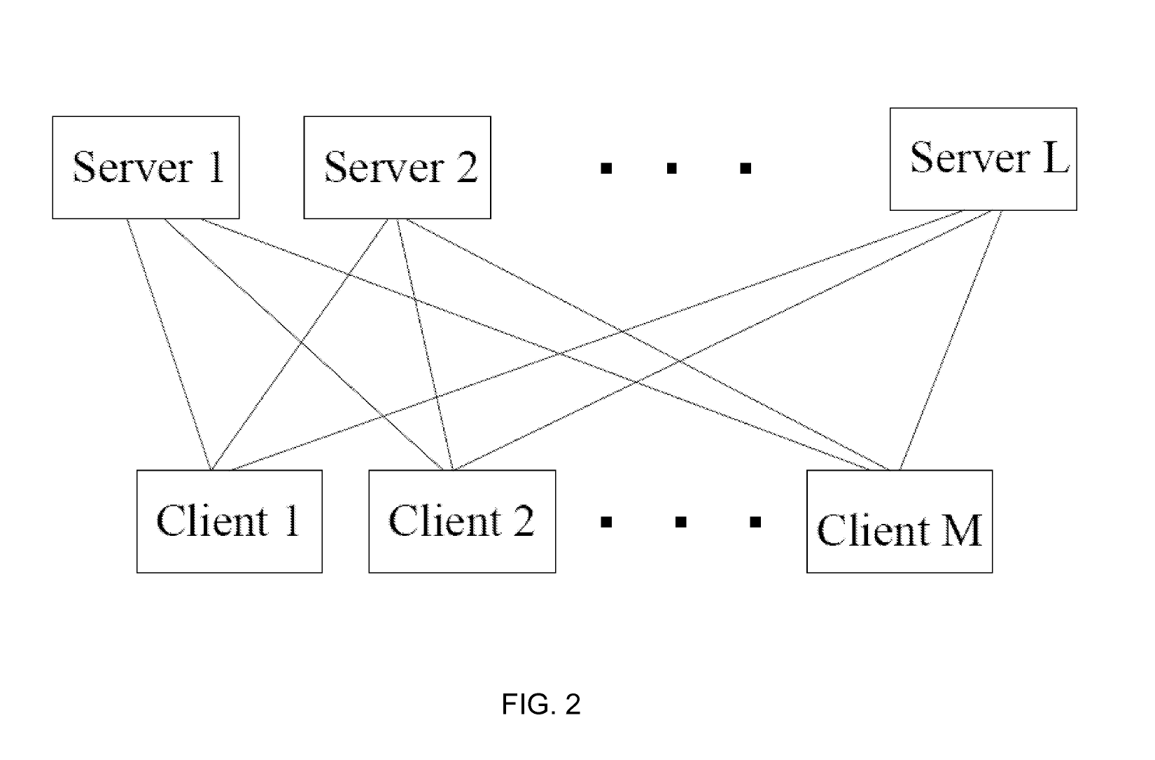

Referring to FIG. 2, the corpus may be divided and loaded into a number of clients. The n-gram counts can be collected at each client. The n-gram counts may then be mapped and stored in a number of servers. In one embodiment, this results in one server being contacted per n-gram when computing the language model probability of a sentence. In further embodiments, any number of servers may be contacted per n-gram. Accordingly, the servers may then be suitable to perform iterations of the N-best list approximate EM algorithm.

Referring still to FIG. 2, the corpus can be divided and loaded into a number of clients according to a Map Reduce paradigm. For example, a publicly available parser to may be used to parse the sentences in each client to obtain the initial counts for w₋ₙ₊₁⁻¹wh₋ₘ⁻¹g etc., and finish the Map part The counts for a particular w₋ₙ₊₁⁻¹wh₋ₘ⁻¹g at different clients can be summed up and stored in one of the servers by hashing through the word w₋₁ (or h₋₁) and its topic g to finish the Reduce part in order to initialize the N-best list approximate EM step. Each client may then call the servers for parameters to perform synchronous multi-stack search for each sentence to get the N-best list parse trees. Again, the expected count for a particular parameter of w₋ₙ₊₁⁻¹wh₋ₘ⁻¹g at the clients are computed to finish a Map part. The expected count may then be summed up and stored in one of the servers by hashing through the word w₋₁ (or h₋₁) and its topic g to finish the Reduce part. The procedure may be repeated until convergence. Alternatively, training corpora may be stored in suffix arrays such that one sub-corpus per server serves raw counts and test sentences are loaded in a client. Moreover, the distributed architecture can be utilized to perform the follow-up EM algorithm to re-estimate the composite word predictor.

In order that the invention may be more readily understood, reference is made to the following examples which are intended to illustrate the embodiments described herein, but not limit the scope thereof.

We have trained our language models using three different training sets: one has 44 million tokens, another has about 230 million tokens, and the other has about 1.3 billion tokens. An independent test set which has about 354 thousand tokens was chosen. The independent check data set used to determine the linear interpolation coefficients had about 1.7 million tokens for the about 44 million tokens training corpus, about 13.7 million tokens for both about 230 million and about 1.3 billion tokens training corpora. All these data sets were taken from the LDC English Gigaword corpus with non-verbalized punctuation (all punctuation was removed for testing). Table 1 provides the detailed information on how these data sets were chosen from the LDC English Gigaword corpus.

TABLE 1
The corpora are selected from the LDC English Gigaword corpus
and specified in this table, AFP, AFW, NYT, XIN and CNA denote
the sections of the LDC English Gigaword corpus.

| | 1.3 BILLION TOKENS TRAINING CORPUS |
|---|---|
| AFP | 19940512.0003~19961015.0568 |
| AFW | 19941111.0001~19960414.0652 |
| NYT | 19940701.0001~19950131.0483 |
| NYT | 19950401.0001~20040909.0063 |
| XIN | 19970901.0001~20041125.0119 |
| | 230 MILLION TOKENS TRAINING CORPUS |
| AFP | 19940622.0336~19961031.0797 |
| APW | 19941111.0001~19960419.0765 |
| NYT | 19940701.0001~19941130.0405 |
| | 44 MILLION TOKENS TRAINING CORPUS |
| AFP | 19940601.0001~19950721.0137 |
| | 13.7 MILLION TOKENS CHECK CORPUS |
| NYT | 19950201.0001~19950331.0494 |
| | 1.7 MILLION TOKENS CHECK CORPUS |
| AFP | 19940512.0003~19940531.0197 |
| | 354K TOKENS TEST CORPUS |
| CNA | 20041101.0006~20041217.0009 |

The vocabulary sizes in all three cases were: word (also word predictor operation) vocabulary was set to 60 k, open—all words outside the vocabulary are mapped to the <unk> token, these 60 k words are chosen from the most frequently occurred words in 44 millions tokens corpus; POS tag (also tagger operation) vocabulary was set to 69, closed; non-terminal tag vocabulary was set to 54, closed; and constructor operation vocabulary was set to 157, closed.

After the parses completed headword percolation and binarization, each model component of word predictor, tagger, and constructor was initialized from a set of parsed sentences. The “openNLP” software (Northedge, 2005) was utilized to parse a large amount of sentences in the LDC English Gigaword corpus to generate an automatic tree bank. For the about 44 and about 230 million tokens corpora, all sentences were automatically parsed and used to initialize model parameters, while for the about 1.3 billion tokens corpus, the sentences were parsed from a portion of the corpus that contained 230 million tokens. The sentences were then used to initialize model parameters. The parser at “openNLP” was trained by the Upenn treebank with about 1 million tokens.

The algorithms described herein were implemented using C++ and a supercomputer center with MPI installed and more than 1000 core processors. The 1000 core processors were used to train the composite language models for the about 1.3 billion tokens corpus (900 core processors were used to store the parameters alone). Linearly smoothed n-gram models were utilized as the baseline for the comparisons, i.e., trigram as the baseline model for 44 million token corpus, linearly smoothed 4-gram as the baseline model for 230 million token corpus, and linearly smoothed 5-gram as the baseline model for 1.3 billion token corpus.

Table 2 shows the perplexity results and computation time of composite n-gram/PLSA language models that were trained on three corpora.

TABLE 2
Perplexity (ppl) results and time consumed of composite n-gram/PLSA
language model trained on three corpora when different numbers of most
likely topics are kept for each document in PLSA.

| | | # OF | | TIME | # OF | # OF | # OF TYPES |
|---|---|---|---|---|---|---|---|
| CORPUS | n | TOPICS | PPL | (HOURS) | SERVERS | CLIENTS | OF ww₋ₙ₊₁⁻¹ g |
| 44M | 3 | 5 | 196 | 0.5 | 40 | 100 | 120.1M |
| | 3 | 10 | 194 | 1.0 | 40 | 100 | 218.6M |
| | 3 | 20 | 190 | 2.7 | 80 | 100 | 537.8M |
| | 3 | 50 | 189 | 6.3 | 80 | 100 | 1.123B |
| | 3 | 100 | 189 | 11.2 | 80 | 100 | 1.616B |
| | 3 | 200 | 188 | 19.3 | 80 | 100 | 2.280B |
| 230M | 4 | 5 | 146 | 25.6 | 280 | 100 | 0.681B |
| 1.3B | 5 | 2 | 111 | 26.5 | 400 | 100 | 1.790B |
| | 5 | 5 | 102 | 75.0 | 400 | 100 | 4.391B |

The pre-defined number of total topics was about 200, but different numbers of most likely topics were kept for each document in PLSA, the rest were pruned. For the composite 5-gram/PLSA model trained on the about 1.3 billion tokens corpus, 400 cores were used to keep the top five most likely topics. For the composite trigram/PLSA model trained on the about 44 million tokens corpus, the computation time increased with less than 5% percent perplexity improvement. Accordingly, the top five topics were kept for each document from total 200 topics (195 topics were pruned).

All of the composite language models were first trained by performing N-best list approximate EM algorithm until convergence, then EM algorithm for a second stage of parameter re-estimation for word predictor and semantizer (for models including a semantizer) until convergence. The size of topics in PLSA models were fixed to be 200 and then pruned to 5 in the experiments, where the un-pruned 5 topics generally accounted for about 70% probability in p(g|d).

Table 3 shows comprehensive perplexity results for a variety of different models such as composite n-gram/m-SLM, n-gram/PLSA, m-SLM/PLSA, their linear combinations, and the like. Three models are missing from Table 3 (marked by “-”) because the size of corresponding model was too big to store in the supercomputer.

TABLE 3
Perplexity results for various language models on test corpus. where + denotes
linear combination. / denotes composite model; n denotes the order of n-gram and
m denotes the order of SLM; the topic nodes are pruned from 200 to 5.

| | 44M | | 230M | | 1.3B | |
|---|---|---|---|---|---|---|
| LANGUAGE MODEL | n = 3, m = 2 | REDUCTION | n = 4, m = 3 | REDUCTION | n = 5, m = 4 | REDUCTION |
| BASELINE n-GRAM (LINEAR) | 262 | | 200 | | 138 | |
| n-GRAM (KNESER-NEY) | 244 | 6.9% | 183 | 8.5% | — | — |
| m-SLM | 279 | −6.5% | 190 | 5.0% | 137 | 0.0% |
| PLSA | 825 | −214.9% | 812 | −306.0% | 773 | −460.0% |
| n-GRAM + m-SLM | 247 | 5.7% | 184 | 8.0% | 129 | 6.5% |
| n-GRAM + PLSA | 235 | 10.3% | 179 | 10.5% | 128 | 7.2% |
| n-GRAM + m-SLM + PLSA | 222 | 15.3% | 175 | 12.5% | 123 | 10.9% |
| n-GRAM/m-SLM | 243 | 7.3% | 171 | 14.5% | (125) | 9.4% |
| n-GRAM/PLSA | 196 | 25.2% | 146 | 27.0% | 102 | 26.1% |
| m-SLM/PLSA | 198 | 24.4% | 140 | 30.0% | (103) | 25.4% |
| n-GRAM/PLSA + m-SLM/PLSA | 183 | 30.2% | 140 | 30.0% | (93) | 32.6% |
| n-GRAM/m-SLM + m-SLM/PLSA | 183 | 30.2% | 139 | 30.5% | (94) | 31.9% |
| n-GRAM/m-SLM + n-GRAM/PLSA | 184 | 29.8% | 137 | 31.5% | (91) | 34.1% |
| n-GRAM/m-SLM + n-GRAM/PLSA + | 180 | 31.3% | 130 | 35.0% | — | — |
| m-SLM/PLSA | | | | | | |
| n-GRAM/m-SLM/PLSA | 176 | 32.8% | — | — | — | — |

An online EM algorithm was used with fixed learning rate to re-estimate the parameters of the semantizer of the test document. The m-SLM performed competitively with its counterpart n-gram (n=m+1) on large scale corpus. In Table 3, for the composite n-gram/m-SLM model (n=3,m=2 and n=4,m=3) trained on about 44 million tokens and about 230 million tokens, the fractional expected counts were cut off when less than a threshold of about 0.005, which reduced the number of predictor's types by about 85%. When the composite language was trained on about 1.3 billion tokens corpus, the parameters of word predictor were pruned and the order of n-gram and m-SLM were reduced for storage on the supercomputer. In one example, the composite 5-gram/4-SLM model was too large to store. Thus, an approximation was utilized, i.e., a linear combination of 5-gram/2-SLM and 2-gram/4-SLM. The fractional expected counts for the 5-gram/2-SLM and the 2-gram/4-SLM were cut off, when less than a threshold of about 0.005, which reduced the number of predictor's types by about 85%. The fractional expected counts for the composite 4-SLM/PLSA model was cut off when less than a threshold of about 0.002, which reduced the number of predictor's types by about 85%. All the tags were ignored and only the words in the 4 head words were used for the composite 4-SLM/PLSA model or its linear combination with other models. The composite n-gram/m-SLM/PLSA model demonstrated perplexity reductions, as shown in Table 3, over baseline n-grams, n=3, 4, 5 and m-SLMs, m=2, 3, 4.

The composite 5-gram/2-SLM+2-gram/4-SLM+5-gram/PLSA language model trained by about 1.3 billion word corpus was applied to the task of re-ranking the N-best list in statistical machine translation. The 1000-best generated on 919 sentences from the MT03 Chinese-English evaluation set by Hiero was utilized. Its decoder used a trigram language model trained with modified Kneser-Ney smoothing on an about 200 million tokens corpus. Each translation had 11 features (including one language model). A composite language model as described herein was substituted and MERT was utilized to optimize the BLEU score. The data was partitioned into ten pieces, 9 pieces were used as training data to optimize the BLEU score by MERT. The remaining piece was used to re-rank the 1000-best list and obtain the BLEU score. The cross-validation process was then repeated 10 times (the folds), with each of the 10 pieces used once as the validation data. The 10 results from the folds were averaged to produce a single estimation for BLEU score. Table 4 shows the BLEU scores through 10-fold cross-validation.

TABLE 4
10-fold cross-validation BLEU score results
for the task of re-ranking the N-best list.

| SYSTEM MODEL | MEAN (%) |
|---|---|
| BASELINE | 31.75 |
| 5-GRAM | 32.53 |
| 5-GRAM/2-SLM + 2-GRAM/4-SLM | 32.87 |
| 5-GRAM/PLSA | 33.01 |
| 5-GRAM/2-SLM + 2-GRAM/4-SLM + | 33.32 |
| 5-GRAM/PLSA | |

The composite 5-gram/2-SLM+2-gram/4-SLM+5-gram/PLSA language model demonstrated about 1.57% BLEU score improvement over the baseline and about 0.79% BLEU score improvement over the 5-gram. It is expected that putting the composite language models described herein into a one pass decoder of both phrase-based and parsing-based MT systems should result in further improved BLEU scores.

“Readability” was also considered. Translations were sorted into four groups: good/bad syntax crossed with good/bad meaning by human judges. The results are tabulated in Table 5.

TABLE 5
Results of “readability” evaluation on 919
translated sentences, P: perfect, S: only semantically
correct, G: only grammatically correct, W: wrong.

| SYSTEM MODEL | P | S | G | W |
|---|---|---|---|---|
| BASELINE | 95 | 398 | 20 | 406 |
| 5-GRAM | 122 | 406 | 24 | 367 |
| 5-GRAM/2-SLM + | 151 | 425 | 33 | 310 |
| 2-GRAM/4-SLM + | | | | |
| 5-GRAM/PLSA | | | | |

An increase in perfect sentenced, grammatically correct sentences, and semantically correct sentences were observed. The composite 5-gram/2-SLM+2-gram/4-SLM+5-gram/PLSA language model demonstrated such improvements.

It should now be understood that complex and powerful but computationally tractable language models may be formed according the directed MRF paradigm and trained with convergent N-best list approximate Expectation-Maximization algorithm and a follow-up Expectation-Maximization algorithm. Such composite language models may integrate many existing and/or emerging language model components where each component focuses on specific linguistic phenomena like syntactic, semantic, morphology, pragmatics et al. in complementary, supplementary and coherent ways.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A composite language model comprising a composite word predictor, wherein:
the composite word predictor is stored in one or more memories, and comprises a first language model and a second language model that are combined according to a directed Markov random field;
the composite word predictor predicts, automatically with one or more processors that are communicably coupled to the one or more memories, a next word based upon a first set of contexts and a second set of contexts;
the first language model comprises a first word predictor that is dependent upon the first set of contexts;
the second language model comprises a second word predictor that is dependent upon the second set of contexts; and
composite model parameters are determined by multiple iterations of a convergent N-best list approximate Expectation-Maximization algorithm and a follow-up Expectation-Maximization algorithm applied in sequence, wherein the convergent N-best list approximate Expectation-Maximization algorithm and the follow-up Expectation-Maximization algorithm extracts the first set of contexts and the second set of contexts from a training corpus.

2. The composite language model of claim 1, wherein:
the composite word predictor further comprises a third language model that is combined with the first language model and the second language model according to the directed Markov random field;
the composite word predictor predicts the next word based upon a third set of contexts;
the third language model comprises a third word predictor that is dependent upon the third set of contexts; and
the convergent N-best list approximate Expectation-Maximization algorithm and the follow-up Expectation-Maximization algorithm extracts the third set of contexts from the training corpus.

3. The composite language model of claim 2, wherein the first language model is a Markov chain source model, the second language model is a probabilistic latent semantic analysis model, and the third language model is a structured language model.

4. The composite language model of claim 1, wherein the convergent N-best list approximate Expectation-Maximization algorithm and the follow-up Expectation-Maximization algorithm are stored and executed by a plurality of machines.

5. The composite language model of claim 1, wherein the first language model is a Markov chain source model, and the second language model is a probabilistic latent semantic analysis model.

6. The composite language model of claim 1, wherein the first language model is a Markov chain source model, and the second language model is a structured language model.

7. The composite language model of claim 1, wherein the first language model is a probabilistic latent semantic analysis model, and the second language model is a structured language model.
